(19) United States
(12) Patent Application Publication
(10) Pub. No.: US 2012/0257230 A1
(43) Pub. Date: Oct. 11, 2012

(54) IMAGE READING APPARATUS, CONTROL METHOD OF IMAGE READING APPARATUS, AND STORAGE MEDIUM

(75) Inventor: Noritsugu Okayama, Kawasaki-shi (JP)

(73) Assignee: CANON KABUSHIKI KAISHA, Tokyo (JP)

(21) Appl. No.: 13/434,636

(22) Filed: Mar. 29, 2012

(30) Foreign Application Priority Data
Apr. 5, 2011 (JP) 2011-083687

(51) Int. Cl. G06K 15/16

(52) U.S. Cl. 358/1.12

(57) ABSTRACT

An image reading apparatus includes a feeding unit, a reading unit, a storing unit, a determining unit, and a control unit. The control unit controls the reading unit so that an image on a second side of a first document is read after a first side of the first document is read and a first side of a second document following the first document is read when it is determined that a free capacity of the storing unit is equal to or greater than a predetermined size. Also, the first side of the second document is read after the first side of the first document fed by the feeding unit is read and the image on the second side of the first document is read when it is determined that the free capacity of the storing unit is not equal to or greater than the predetermined size.

### BACKGROUND OF THE INVENTION

1. Field of the Invention

The present invention relates to an image reading apparatus, a control method of an image reading apparatus, and a storage medium.

2. Description of the Related Art

An image reading apparatus provided in a copying machine or a multifunctional peripheral is configured to read a document that is being conveyed so that the read image data undergoes image processing to be printed by a recording unit, or is transmitted as a facsimile document through a communication unit. Some image reading apparatuses include an automatic document feeder for automatically feeding documents one by one from the stacked documents.

On the other hand, some image reading apparatuses do not include an automatic document feeder. In such a case, a user needs to place documents one by one to be read, causing extra labor to the user. Accordingly, an automatic document feeder is a very useful device for a user to improve productivity.

Among automatic document feeders, there is a feeder having an automatic two-sided document feeding function for automatically reading a two-sided document. According to a method for automatically feeding a two-sided document, for example, first a front side of the document is read. Then, the document is reversed inside a reading unit, and a back side thereof is read. The document cannot be discharged as it is since the position thereof is reversed from an input position. Accordingly, the document is re-reversed inside the reading unit after the back side thereof is read, so that the document is returned to an original orientation and is discharged.

The automatic two-sided document feeder, therefore, is a useful function to automatically read a two-sided document while saving user labor. However, such an automatic two-sided document feeder includes a time period during which a document cannot be read, for example, when a document is being reversed after a front side thereof is read, and when a document is being re-reversed after a back side thereof is read. Such a time period causes a reading speed of a two-sided document to be decreased than that of a one-sided document.

For example, Japanese Patent Application Laid-Open No. 2006-327728 discusses a technique for improving performance degradation of two-sided document reading due to a performance difference between one-sided document reading and two-sided document reading in an automatic document feeder.

An image reading apparatus discussed in Japanese Patent Application Laid-Open No. 2006-327728 executes reading control when a plurality of small-sized documents are simultaneously read, i.e., the size of the documents is small relative to that of a sheet conveyance path of the automatic document feeder. Specifically, the reading control is executed as follows. The image reading apparatus successively reads front sides of the documents, and then successively reads back sides of the documents. Such reading control can shorten a time period at which a document cannot be read in the course of reversing thereof, thereby enhancing the performance of two-sided document reading.

In such a conventional reading method, however, images on front sides of a plurality of documents to be read first need to be stored before a first sheet of a print product is printed. If a memory capacity is not sufficient to store therein the front side images of the plurality of documents, the document reading cannot be executed.

### SUMMARY OF THE INVENTION

According to an aspect of the present invention, an image reading apparatus includes a feeding unit configured to feed a document, a reading unit configured to read a first side of the document fed by the feeding unit and an image on a second side of the document by reversing the document, a storing unit configured to store image data of the document read by the reading unit, a determining unit configured to determine whether a free capacity of the storing unit is equal to or greater than a predetermined size, and a control unit configured to control the reading unit so that, for a first document and a second document fed by the feeding unit, an image on a second side of the first document is read after a first side of the first document fed by the feeding unit is read and a first side of the second document following the first document is read in a case where the determining unit determines that the free capacity of the storing unit is equal to or greater than the predetermined size, and configured to control the reading unit so that the first side of the second document following the first document is read after the first side of the first document fed by the feeding unit is read and the image on the second side of the first document is read in a case where the determining unit determines that the free capacity of the storing unit is not equal to or greater than the predetermined size.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image forming apparatus including an image reading apparatus according to a first exemplary embodiment.

FIG. 2 is a diagram illustrating an external appearance of the image forming apparatus illustrated in FIG. 1.

FIG. 3 illustrates cross-section views each illustrating a conveyance state of a document to be read by a reading unit illustrated in FIG. 1.

FIG. 4 is a cross-section view illustrating a conveyance path of the image reading apparatus according to an exemplary embodiment.

FIG. 5 illustrates cross-section views each illustrating a document conveyance state in the image reading apparatus illustrated in FIG. 4.

FIG. 6 is a diagram illustrating a document reading mode to be performed by the image reading apparatus according to the exemplary embodiment.

FIG. 7 is a flowchart illustrating a control procedure of the image reading apparatus according the exemplary embodiment.

### DESCRIPTION OF THE EMBODIMENTS

Various exemplary embodiments, features, and aspects of the invention will be described in detail below with reference to the drawings.

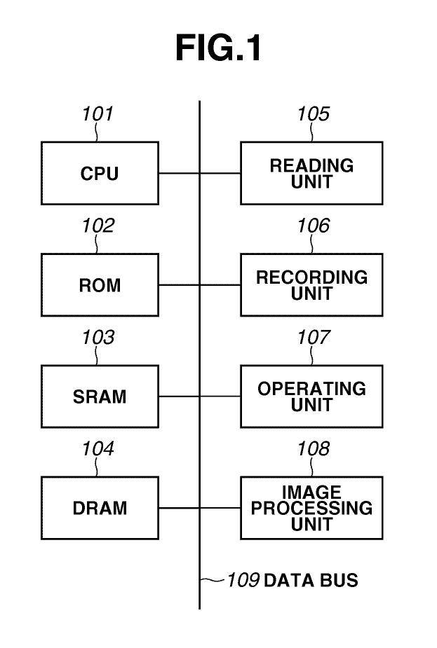

FIG. 1 is a block diagram illustrating an image forming apparatus including an image reading apparatus according to a first exemplary embodiment.

In FIG. 1, a central processing unit (CPU) 101 serves as a control unit of a system and controls the entire apparatus. A read only memory (ROM) 102 stores therein a control program to be executed by the CPU 101. A static random access memory (SRAM) 103 stores therein, for example, setting values and apparatus management data registered by an operator, or buffers for various works. A dynamic random access memory (DRAM) 104 stores therein, for example, image data and program control variables.

A reading unit 105 including a line image sensor reads an image on a document that is being conveyed in a predetermined position, and converts the image into binary data. The image forming apparatus can execute a copy function in which the image data read by the reading unit 105 is printed by a recording unit 105.

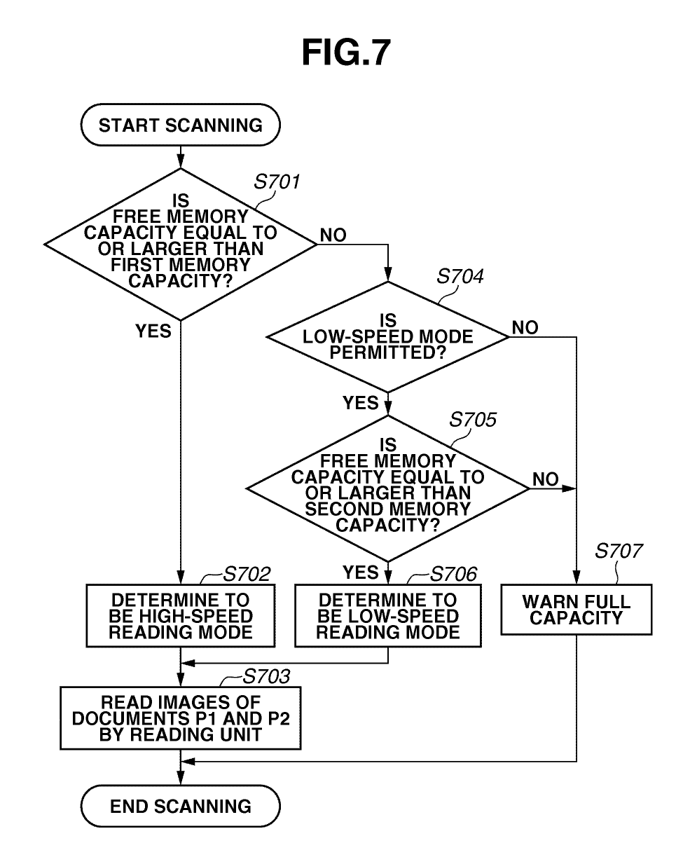

The CPU 101 determines whether the DRAM 104 can secure a free capacity in which image data for approximately three pages is stored based on a document to be read by the reading unit 105. More specifically, the CPU 101 determines whether the DRAM 104 has a free capacity equal to or greater than a first memory capacity according to the procedure described below with reference to FIG. 7.

Herein, the first memory capacity differs depending on reading modes of the reading unit 105. For example, the first memory capacity serving as a reference differs depending on whether the reading unit 105 is capable of reading a color document or a monochrome document only.

The reading reference is, for example, A4 size as a standard document and same size magnification reading as a standard reference. However, the reading reference may be a combination of other references. The second memory capacity represents a memory capacity that is smaller than the first memory capacity, and can store therein at least data for two pages. When a user uses an operating unit 107 to designate resolution of the document to be read, the standard reference is changed.

The reading unit 105 includes an automatic document feeder for automatically feeding a document to a position in which the reading unit 105 is disposed. Further, the reading unit 105 includes an automatic two-sided document feeder. The automatic two-sided document feeder reverses a reading side of a two-sided document using a conveyance path for reversing and conveying the two-sided document in the automatic document feeder, and reads front and back sides of the two-sided document.

The recording unit 106 prints image data on a recording sheet. The recording unit 106 can print image data on two sides of a recording sheet. The operating unit 107 functions as an interface unit with a user, and displays thereon information of the apparatus. For example, a user can perform settings for various devices or check setting contents through the operating unit 107. Moreover, a user can use the operating unit 107 to change various settings. With the operating unit 107, the user sets a plurality of setting items according to a function to be executed.

The information changed by using the operating unit 107 is stored in the SRAM 103. An image processing unit 108 performs encoding processing or decoding processing with respect to image data read by the reading unit 105. The CPU 101 can acquire image data from a device connected through a data bus 109, and can transfer the acquired image data to the recording unit 106.

According to the present exemplary embodiment, the CPU 101 controls driving of a feeding unit for feeding or reversely feeding a two-sided document placed on a document positioning plate using a plurality of conveyance paths. At that time, the CPU 101 controls driving of rollers provided on conveyance paths to be used for feeding the document, so that the document is fed or reversely fed. At that time, the CPU 101 reads an image on a front side of the document being fed or an image on a back side of the document being reversely fed by the feeding unit in a predetermined position, and stores the image data read by the reading unit 105 from the document on the DRAM 104.

The reading unit 105 has a first reading mode in which a front side of a document being fed is read, and a back side of the document being reversely fed by the feeding unit is read. Further, the reading unit 105 has a second mode in which front sides of first and second documents being fed are read, and back sides of the first and second documents being reversely fed by the feeding unit are read.

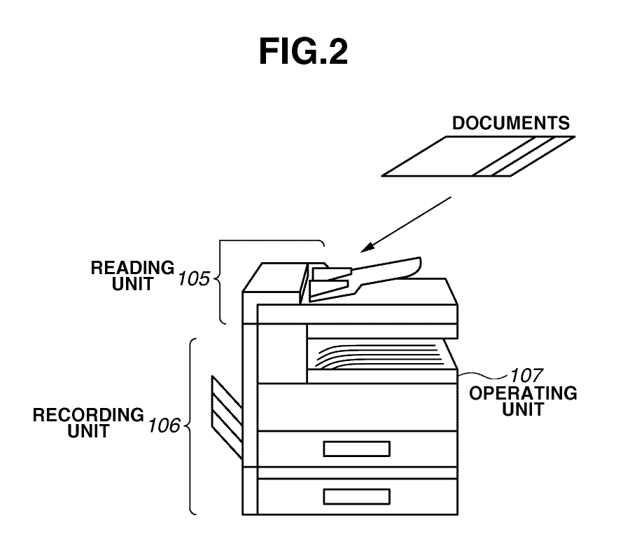

FIG. 2 illustrates an external appearance of the image forming apparatus illustrated in FIG. 1. In FIG. 2, a document is set on a document positioning plate on a document feeder of the reading unit 105. A description is given below of the procedure of a copy operation including reading and copying a two-sided document set on the document positioning plate.

In the copy operation, a document is placed on the reading unit 105, and is read by the reading unit 105 by one side when the reading unit 105 receives a copy operation instruction from the operating unit 107. Subsequently, the image data read by the reading unit 105 is printed by the recording unit 106. Since the reading unit 105 includes the automatic document feeder, a plurality of two-sided documents are automatically fed and reversely fed using a plurality of conveyance paths, thereby reading images on each two-sided document.

The reading unit 105 outputs read image data of each side of the two-sided document to the recording unit 106, so that the two-side document is copied and output by the recording unit 106.

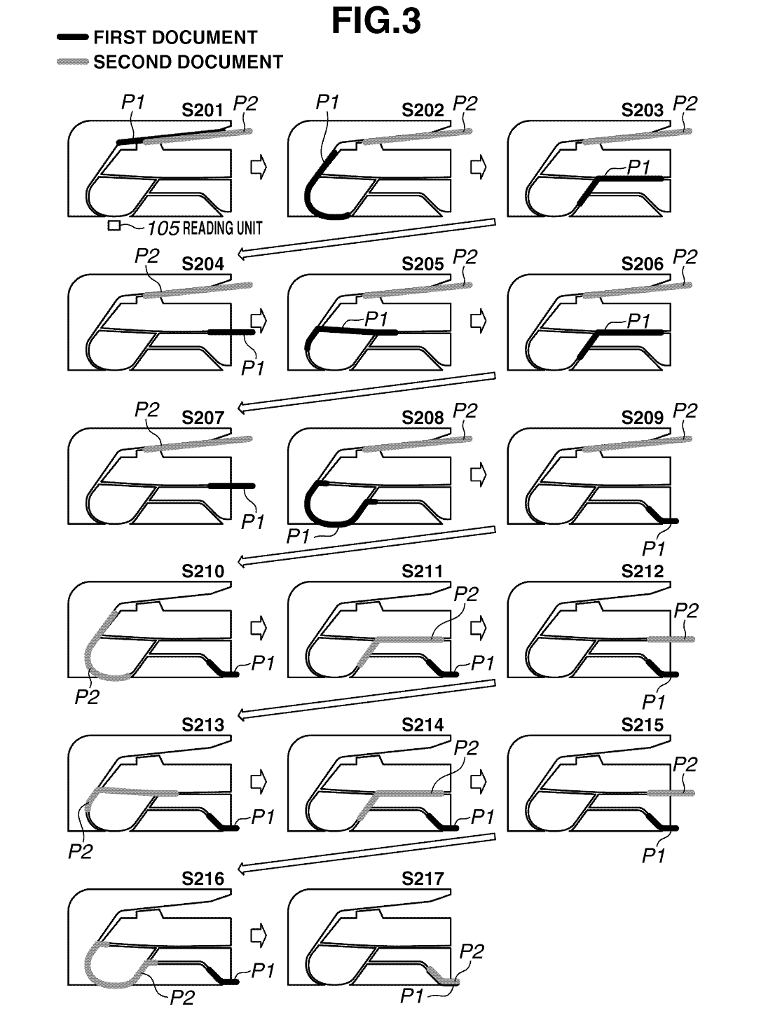

FIG. 3 illustrates cross-section views each illustrating a conveyance state of a document to be read by the reading unit 105 illustrated in FIG. 1. FIG. 3 illustrates an example where two-sided documents placed on a document positioning plate are separated and fed one by one, and the reading unit 105 reads an image on a front side and an image on a back side of each of the two-sided document in this order.

In FIG. 3, when two sheets of documents, whose front sides thereof is set upward by the automatic document feeder, are placed one on another on a document positioning plate, and a user provides an instruction for two-sided document reading through the operating unit 107, the CPU 101 controls operation of the reading unit 105 and the recording unit 106 as follows.

First, a first document P1 is conveyed on a conveyance path in a direction toward the reading unit 105 (S201). The first document P1 passes over the reading unit 105 with a front side thereof oriented downward, so that the front side thereof is scanned (S202). In this example, a platen glass is disposed over the reading unit 105, and the front side of the document P1 is oriented downward and conveyed on the glass such that the document P1 passes over the reading unit 105.

Upon completion of reading the front side of the first document P1, the document P1 is revered by using a reverse conveyance path so that a back side of the document P1 is read. Accordingly, the document P1 is once conveyed forward for reverse preparation (S203 and S204).

Subsequently, the reversed document P1 is fed toward the reading unit 105 again so that the reading unit 105 reads the back side of the first document P1 (S205). At that time, the back side of the document P1 is oriented upward, and the document P1 is conveyed from a tailing edge thereof. The document P1 is conveyed along the conveyance path to pass over the reading unit 105 again with the back side thereof oriented downward. Thus, the reading unit 105 reads the back side of the document P1 (S206).

Accordingly, the front and back sides of the document P1 are read. However, the document P1 is discharged in a reversed state with respect to the original state placed on the document positioning plate. Accordingly, the document P1 needs to be reversed again before being discharged.

The document P1 is conveyed forward again for reverse preparation (S207). The document P1 passes through substantially the same conveyance path and is reversed again (S208). Lastly, the document P1 passes through a discharge conveyance path and is discharged (S209).

When the reading of the front and back sides of the first document P1 is finished, the reading of a second document P2 is started (S210). The operation of reading the two-sided document P2 is illustrated in FIG. 3 (S210 through S217). Since the operation of reading the second document P2 is substantially the same as that of the first document P1, the description thereof is omitted.

Therefore, such an operation of the two-sided document reading by a conventional automatic document feeder is realized by reading a front side of the document, reversing the document, reading aback side of the document, re-reversing the document, and discharging the document in sequence. Such an automatic document feeder, however, includes a time period during which the reading unit 105 is not in operation when a two-sided document is read. Such a time period causes performance degradation of the two-sided document reading.

On the other hand, when one-sided documents are read, the documents are fed one after another from an automatic document feeder. Thus, the reading unit 105 can be constantly in operation. When a document is being scanned by the reading unit 105, a next document to be read is conveyed beforehand to a position just in front of the reading unit 105, so that documents are read by the reading unit 105 with little interval therebetween.

In the two-sided document reading, when a front side of a document is being read, a next side to be read is a back side of the same document. Therefore, the next reading document cannot be conveyed beforehand to a position just in front of the reading unit 105. Accordingly, after an image on the front side is read by the reading unit 105, the document is reversed, causing an increase in a length of a time period until the reading of an image on the back side is started (S203 through S205). Consequently, the increased time period causes reading performance of a two-sided document to be slower than that of a one-sided document.

In the above example, during the re-reversing periods (S206 to S208) subsequent to reading the image on the back side, the first document P1 uses the path on which the second document P2 passes. Consequently, the second document P2 cannot be read in the course of re-reversing the first document P1.

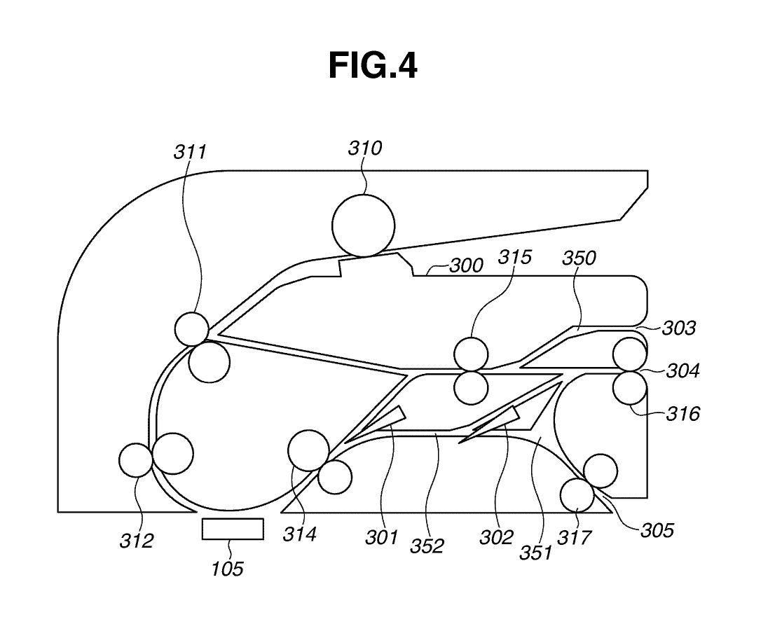

Therefore, the reading performance of the two-sided document is slower than that of the one-sided document. An automatic document feeder is proposed which increases efficiency by solving such a disadvantage of the two-sided document reading by changing reading order. One example of such an automatic document feeder is illustrated in FIG. 4.

FIG. 4 is a cross-section view illustrating conveyance paths of the image reading apparatus according to the present exemplary embodiment. The automatic document feeder illustrated in this example includes two conveyance paths, and switches the paths using flappers 301 and 302.

In a first conveyance path, when a document is placed on a document positioning plate 300, and a reading start instruction is provided through the operating unit 107, the CPU 101 drives rollers 310, 311, and 312 to convey the document. When the document passes through the reading unit 105, an image on the document is read by the reading unit 105. Subsequently, the CPU 101 drives a roller 314 to convey the document to an upper conveyance path 350 while the flapper 301 is being arranged downward. The CPU 101 drives a roller 315 to once retract the document in an upper reversing outlet port 303.

After reversing the document, the CPU 101 drives the rollers 315, 311, and 312 to convey the document. When the document passes through the reading unit 105, an image on aback side thereof is read by the reading unit 105. Subsequently, the CPU 101 allows the document to be conveyed to a lower conveyance path 351 while the flapper 302 is being arranged upward in a state where the flapper 301 is arranged upward. The CPU 101 drives a roller 317 to again retract the document in a lower re-reversing outlet port 305.

Lastly, the CPU 101 drives rollers 317 and 316 to discharge the document through a lower reversing outlet port 304.

On the other hand, in a second conveyance path, when a document is placed on the document positioning plate 300, and a reading start instruction is provided through the operating unit 107, the CPU 101 drives the rollers 310, 311, and 312 to convey the document. When the document passes through the reading unit 105, an image on the document is read by the reading unit 105. Subsequently, the CPU 101 drives the roller 314 to convey the document to a lower conveyance path 352 while the flappers 301 and 302 are being arranged upward and downward respectively. Further, the CPU 101 drives the roller 316 to once retract the document in the lower reversing outlet port 304.

After reversing the document, the CPU 101 drives the rollers 315, 311, and 312 to convey the document. When the document passes through the reading unit 105, an image on a back side thereof is read by the reading unit 105. Subsequently, the CPU 101 allows the document to be conveyed through the lower conveyance path 351 while the flappers 301 and 302 are being arranged upward. The CPU 101 drives the roller 317 to again retract the document in the lower re-reversing outlet port 305.

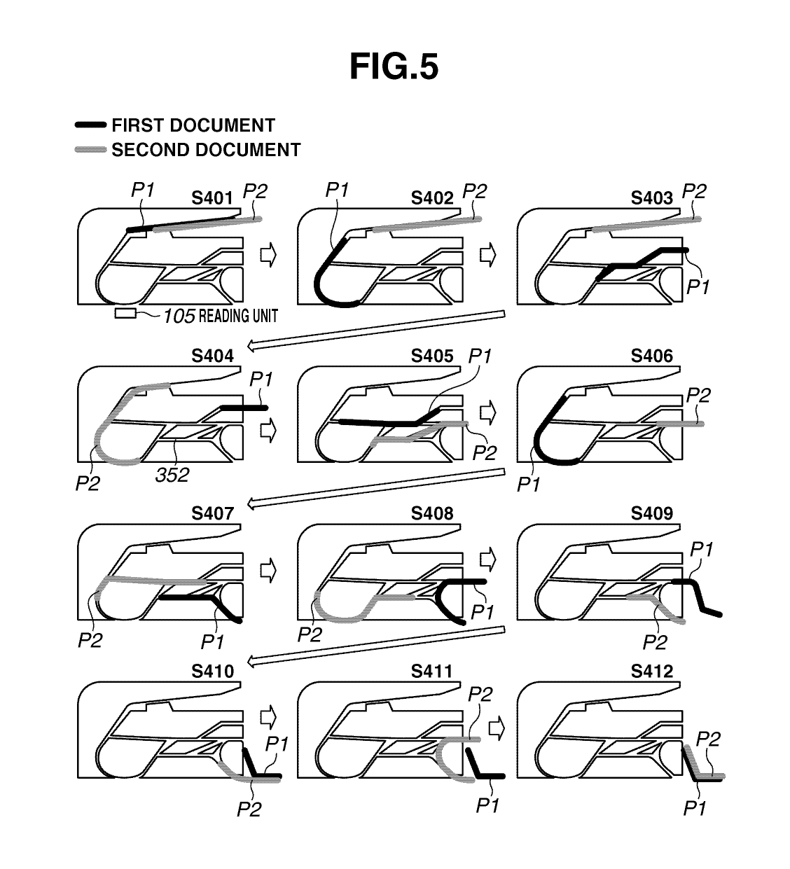

Lastly, the CPU 101 drives rollers 317 and 316 to discharge the document from the lower reversing outlet port 304. Such an operation of reading the two-sided document by the high efficient automatic document feeder as illustrated in FIG. 4 is described with reference to FIG. 5.

FIG. 5 illustrates cross-section views each illustrating a document conveyance state in the image reading apparatus illustrated in FIG. 4. The reading unit 105 is illustrated in only S401, and is omitted in S402 through S412 in FIG. 5. A description is given of an example operation where an automatic document feeder reads two sheets of documents in two-sided document reading.

In FIG. 5, two sheets of documents are placed one on another on a document positioning plate with front sides thereof upward, and an instruction for two-sided document reading is provided through the operating unit 107 based on a set condition. The CPU 101 first conveys a first document P1 along a conveyance path (S401).

The first document P1 passes through the reading unit 105 with a front side thereof oriented downward, so that an image on the front side of the first document P1 is read (S402). Upon completion of reading the front side of the first document P1, the document P1 is revered so that a back side thereof is read. Accordingly, the CPU 101 once conveys the document P1 forward for reverse preparation. At that time, for example, the flapper is controlled so that the document P1 passes through the upper conveyance path 350.

At this point, an operation for feeding the second document P2 is started to read a front side of the second document P2 (S403). An image on the front side of the second document P2 is read by the reading unit 105 while the first document P1 is being fed forward (S404).

Next, the CPU 101 performs control in such a manner that the reversed first document P1 is conveyed toward the reading unit 105 again to read a back side of the first document P1 by the reading unit 105. Simultaneously, the CPU 101 performs control in such a manner that the second document P2 is fed forward and reversed to read an image on a back side the document P2 by the reading unit 105.

At that time, the CPU 101 performs control in such a manner that the second document P2 passes through the lower conveyance path 352. At that time, the back side of the first document P1 is oriented upward, and the document P1 is conveyed from a tailing edge thereof (S405).

The first document P1 is conveyed along a conveyance path to pass through the reading unit 105 again with the back side thereof oriented downward, and an image on the back side of the first document P1 is read by the reading unit 105. At that time, the CPU 101 controls the second document P2 to be fed forward and revered (S406). The CPU 101 controls the document P1 to be re-reversed since the reading of the front and back sides of the first document P1 is finished.

After passing through the reading unit 105, the first document P1 passes through the lowermost conveyance path 351 and is re-reversed. Simultaneously, the CPU 101 started to perform control so that the second document P2 is conveyed from a tailing edge thereof with a back side thereof upward, and an image on the back side of is read (S407).

Therefore, the first document P1 is reversed in a conveyance path for re-reversing. Simultaneously, the image on the back side of the second document P2 is read by the reading unit 105 (S408).

Then, the first document P1 undergoes a post-reversing discharge operation. Simultaneously, the CPU 101 performs control so that the second document P2 is conveyed to a conveyance path for re-reversing and is reversed (S409). Subsequently, the first document P1 is discharged from the automatic document feeder, whereas the second document P2 is reversed and is then discharged (S410 to S412).

In the image reading apparatus having such a high efficient automatic two-sided document feeder, therefore, high reading efficiency is achieved by reading a second document in the period of reversing a first document. In the automatic two-sided document feeder illustrated in FIG. 2, for example, documents are read in the following order: a front side of a first sheet, a back side of the first sheet, a front side of a second sheet, a back side of the second sheet, a front side of a third sheet, a back side of the third sheet, and so on.

However, in the image reading apparatus illustrated in FIG. 4, documents are read in the following order: a front side of a first sheet, a front side of a second sheet, a back side of the first sheet, aback side of the second sheet, a front side of a third sheet, a front side of a fourth sheet, and so on. Such changes in reading order cause a problem.

For example, assume that a two-sided document is output by two-sided printing. In such a case, front and back sides of a first document P1 are printed on a first sheet of an output product. The first sheet becomes ready to be printed when image data of the front side and image data of the back side of the first document P1 are prepared. In the image reading apparatus illustrated in FIG. 2, for example, when front and back sides of a first sheet are read, a first sheet becomes ready to be printed as data necessary for printing is obtained. Thus, the printing becomes ready to be performed at this point.

However, in the high efficient image reading apparatus, a first sheet becomes ready to be printed when image data for three pages are read. That is, image data of a front side of a first document P1, image data of a front side of a second document P2, and image data of a back side of the document P1 need to be read before the first sheet becomes ready to be printed. In the high efficient image reading apparatus, therefore, when printing a 2-sided document as a 2-sided printing, a memory for storing data for at least three pages (a front side of a first document, a front side of a second document, and a back side of the first document) is needed, because of the difference in the reading order.

In the present exemplary embodiment, the DRAM 104 has a memory area in which image data to be read by the reading unit 105 is stored. Since a capacity of the memory area changes depending on a processing state of the image forming apparatus, the memory area may not store therein image data for three pages all the time.

In the present exemplary embodiment, therefore, the CPU 101 executes any of the processing of waiting a shift between the first reading mode and the second reading mode, and a shift to a state where reading can be started in the first reading mode according to the control procedure illustrated in FIG. 7 described below.

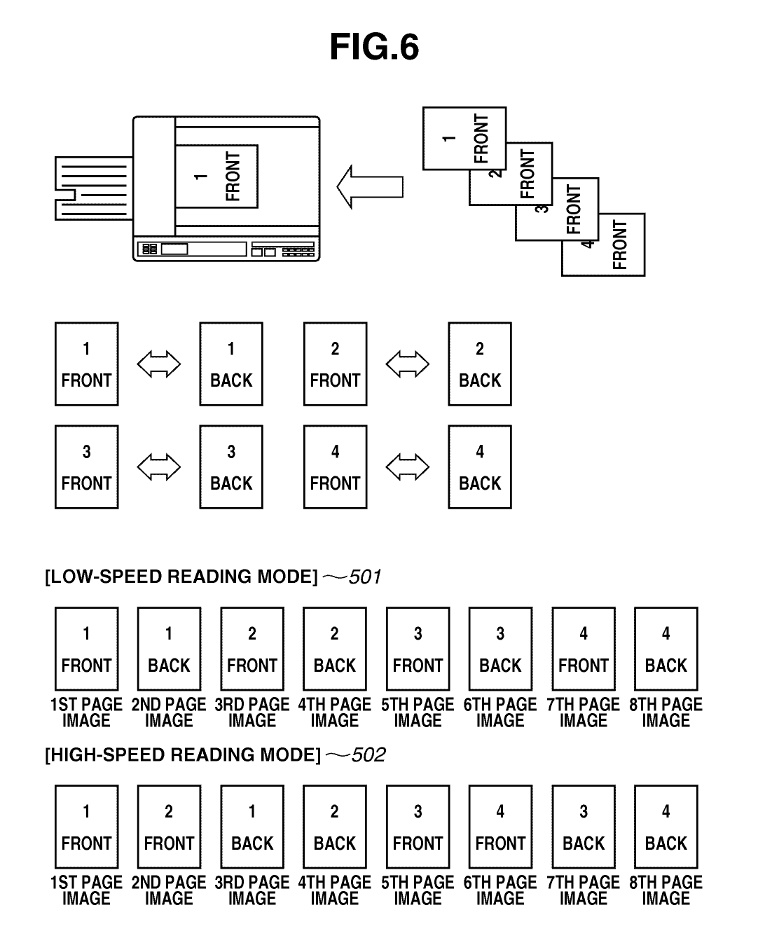

FIG. 6 is a diagram illustrating the document reading mode to be performed by the image reading apparatus according to the present exemplary embodiment. FIG. 6 illustrates an example where the image reading apparatus illustrated in FIG. 4 has two settable document reading modes. This example also illustrates a case where two-sided document reading is performed in a state where four sheets of documents are placed on the image reading apparatus in the reading unit illustrated in FIGS. 2 and 4.

Now, a description is given of reading order in each reading mode when four two-sided documents are placed on one on another with front sides thereof upward.

Assume that a reading order in an image reading apparatus illustrated in FIG. 2 is a low-speed reading mode (a first reading mode) 501. In the low-speed reading mode 501, the documents are conveyed, reversed, and read one by one as illustrated in FIG. 6.

According to the low-speed reading mode 501, the documents are read in the following order: a front side of a first sheet, a back side of the first sheet, a front side of a second sheet, a back side of the second sheet, a front side of a third sheet, a back side of the third sheet, a front side of a fourth sheet, and a back side of the fourth sheet.

Next, a reading mode suitable for the image reading apparatus illustrated in FIG. 4 is described. In the image reading apparatus illustrated in FIG. 4, documents are read in a reading mode different from the first reading mode. The description is given of a case where reading efficiency in reading an image on a document P2 is increased while reversing a first document P1. Such reading is referred to as a high-speed reading mode (a second reading mode) 502. In this example, two pages are read in the high-speed reading mode 502.

In the high-speed reading mode 502 for two pages, the second document P2 is read while the first document P1 is being revered. As illustrated in FIG. 6, the documents are read in the following order: a front side of a first sheet, a front side of a second sheet, a back side of the first sheet, a back side of the second sheet, a front side of a third sheet, a front side of a fourth sheet, a back side of the third sheet, and the back side of the fourth sheet.

The image reading apparatus according to the present exemplary embodiment, therefore, has the two reading modes using different reading orders and conveyance paths.

FIG. 7 is a flowchart illustrating a control procedure of the image reading apparatus according the present exemplary embodiment. In the flowchart of FIG. 7, a reading mode of the reading unit 105 is determined by determining a free capacity in a memory included in the image reading apparatus, in which image data to be read by the reading unit 105 is stored. The CPU 101 executes a reading control program stored in the ROM 102, thereby performing each step of the procedure.

Hereinbelow, a description is given of the procedure for determining a reading mode of the reading unit 105 to be a second reading mode or a first reading mode depending on whether the CPU 101 determines that a memory has a free capacity of equal to or greater than that needed for execution of the second reading mode. In this example procedure, the CPU 101 determines the reading mode before documents placed on a document positioning plate are read.

In step S701, the CPU 101 determines whether the DRAM 104 has a sufficient free capacity when receiving a reading start instruction from a user through the operating unit 107 with respect to a plurality of documents placed on a document positioning plate. More specifically, the CPU 101 determines whether the DRAM 104 can secure a free capacity (a first free memory capacity) for allowing, for example, image data for three pages of A4 sized document to be stored therein, as described below.

A size of the first free memory capacity may be determined beforehand. Alternatively, the CPU 101 may calculate a size of the first free memory capacity based on reading conditions such as reading resolution which is set via the operating unit 107 as a result of detection of a document size or determination of a color/monochrome document.

In the present exemplary embodiment, when a two-sided document is read and printed by the copying operation as described in FIG. 4, the CPU 101 determines whether the DRAM 104 has a free memory capacity for storing image data for three pages or more of predetermined sized document, for example, A4 sized document. A standard resolution and a standard magnification may be added as a condition.

If the CPU 101 determines that the DRAM 104 has a sufficient free capacity (YES in step S701), then in step S702, the CPU 101 determines that the reading mode for the reading unit 105 is the high-speed reading mode 502. Subsequently, in step S703, the CPU 101 performs the reading process on the documents P1 and P2 that is being conveyed, and then the operation is ended.

If the CPU 101 determines that the DRAM 104 does not have a sufficient free capacity due to the structure of the device (NO in step S701), the processing proceeds to step S704. Herein, a size of the free memory capacity for capable of storing image data for three pages or more is exemplified as a reference size. However, the reference size may be changed depending on a job content designated by a user through the operating unit 107.

In step S704, the CPU 101 determines whether information for permitting a low-speed mode is stored in the SRAM 103. Such information is registered in the SRAM 103 beforehand by a user through the operating unit 107.

If the CPU 101 determines that low-speed mode is permitted (YES in step S704), then in step S705, the CPU 101 determines whether the DRAM 104 can secure a second free memory capacity. A size of the second free memory capacity may be determined beforehand. Alternatively, the CPU 101 may calculate a size of the second free memory capacity based on reading conditions such as reading resolution which is set via the operating unit 107 as a result of detection of a document size or determination of a color/monochrome document.

A size of the second memory capacity in step S705 is smaller than that of the first memory capacity in step S701. The second memory capacity serving as a criterion is, for example, a size that allows image data for two pages of A4 sized document to be stored.

If the CPU 101 determines that the DRAM 104 has a sufficient free memory capacity (YES in step S705), then in step S706, the CPU 101 determines that the reading mode for the reading unit 105 is the low-speed reading mode 501. Subsequently, in step S703, the CPU 101 performs the reading processing on the documents P1 and P2 that is being conveyed, and then the operation is ended.

In the present exemplary embodiment, therefore, even if a size of the free capacity to be secured in the DRAM 104 is determined to be equal to or smaller than that needed for execution of the high-speed reading mode 502 corresponding to the second reading mode, the low-speed reading mode 501 corresponding to the first reading mode is executed.

Therefore, if a size of the free capacity is determined to be equal to or greater than that needed for execution of the low-speed reading mode 501 corresponding to the first reading mode, the document reading is not restricted and is executed at a low speed, thereby enhancing user friendliness. The present exemplary embodiment, however, executes the processing in step S704 in consideration of users who do not desire such switching of the reading mode.

For example, a user can set so that the low-speed mode 501 is not permitted when the user can eventually achieve high work efficiency by execution of reading the documents P1 and P2 at the high-speed mode 502 after a sufficient capacity is secured in the DRAM 104.

If the CPU 101 determines that the low-speed mode 501 is not permitted (NO in step S704), then in step S707, the CPU 101 displays on a display unit of the operating unit 107 a warning (e.g., a message) thereon, and the operation is ended. For example, a warning to be displayed may be that the reading unit 105 cannot read a document due to full capacity of the memory (a size of free memory capacity is too small).

After the documents P1 and P2 are read in the high-speed mode 502 or low-speed mode 501 in step S703, a third document and the subsequent documents can be continued to be read in the determined mode.

The control operation according to the present exemplary embodiment is not limited to the two-sided document reading and two-sided copying operation. Therefore, the present exemplary embodiment can be applied to any image reading apparatus capable of reading documents by changing the reading order or a conveyance path according to a size of free capacity in the DRAM 104.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention. In an example, a computer-readable storage medium may store a program that causes an image reading apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-083687 filed Apr. 5, 2011, which is hereby incorporated by reference herein in its entirety.

What is claimed is:

1. An image reading apparatus comprising:
a feeding unit configured to feed a document;
a reading unit configured to read a first side of the document fed by the feeding unit and an image on a second side of the document by reversing the document;
a storing unit configured to store image data of the document read by the reading unit;
a determining unit configured to determine whether a free capacity of the storing unit is equal to or greater than a predetermined size; and
a control unit configured to control the reading unit so that, for a first document and a second document fed by the feeding unit, an image on a second side of the first document is read after a first side of the first document fed by the feeding unit is read and a first side of the second document following the first document is read in a case where the determining unit determines that the free capacity of the storing unit is equal to or greater than the predetermined size, and configured to control the reading unit so that the first side of the second document following the first document is read after the first side of the first document fed by the feeding unit is read and the image on the second side of the first document is read in a case where the determining unit determines that the free capacity of the storing unit is not equal to or greater than the predetermined size.

2. The image reading apparatus according to claim 1, wherein the control unit controls the reading unit so that the first side of the second document following the first document is read after the first side of the first document fed by the feeding unit is read and the image on the second side of the first document is read in a case where the determining unit determines that the free capacity of the storing unit is not equal to or greater than the predetermined size and the first side of the second document following the first document is permitted to be read after the first side of the first document fed by the feeding unit is read and the image on the second side of the first document is read, and
wherein the control unit controls the reading unit not to perform reading in a case where the first side of the second document following the first document is not permitted to be read after the first side of the first document fed by the feeding unit is read and the image on the second side of the first document is read in a case where the determining unit determines that the free capacity of the storing unit is not equal to or greater than the predetermined size.

3. The image reading apparatus according to claim 1, wherein, in a case where the determining unit determines that the free capacity of the storing unit is not equal to or greater than the predetermined size, a display unit is controlled to display an error message in a case where the first side of the second document following the first document is not permitted to be read after the first side of the first document fed by the feeding unit is read and the image on the second side of the first document is read.

4. The image reading apparatus according to claim 1, wherein the predetermined size is a size corresponding to image data for three pages of documents.

5. A control method for controlling an image reading apparatus, the control method comprising:
feeding a document;
reading a first side of the fed document and an image on a second side of the document by reversing the document;
storing, in a storing unit, image data of the read document;
determining whether a free capacity of the storing unit is equal to or greater than a predetermined size; and
controlling so that, for a fed first document and a fed second document, an image on a second side of the first document is read after a first side of the fed first document is read and a first side of the second document following the first document is read in a case where it is determined that the free capacity of the storing unit is equal to or greater than the predetermined size, and controlling so that the first side of the second document following the first document is read after the first side of the fed first document is read and the image on the second side of the first document is read in a case where it is determined that the free capacity of the storing unit is not equal to or greater than the predetermined size.

6. A non-transitory computer readable storage medium storing a computer program that causes an image reading apparatus to perform the control method according to claim 5
